(19) United States
(12) Patent Application Publication
(10) Pub. No.: US 2025/0266646 A1
(43) Pub. Date: Aug. 21, 2025

(54) GROUND BUS FOR A CABLE ASSEMBLY

(71) Applicant: TE Connectivity Solutions GmbH, Schaffhausen (CH)

(72) Inventors: Randall Robert Henry, Lebanon, PA (US); Rakesh K., Bangalore (IN); Brandon Michael Matthews, McAllisterville, PA (US); Brian Patrick Costello, Athens, GA (US)

(21) Appl. No.: 18/444,813

(22) Filed: Feb. 19, 2024

(51) Int. Cl. H01R 13/6471; H01R 12/72; H01R 13/652; H01R 13/6585; H01R 13/6592; H01R 24/60

(52) U.S. Cl. CPC H01R 13/6471; H01R 12/721; H01R 13/652; H01R 13/6585; H01R 13/6592; H01R 24/60

(57) ABSTRACT

A cable assembly includes a contact assembly coupled to cables. The contact assembly includes a contact holder, contacts held by the contact holder, and a ground bus coupled to the contact holder. The contacts include signal contacts and ground contacts held in contact channels. Each contact includes an intermediate section between a forward section and a rearward section. The forward section extends forward of the front of the contact holder. The rearward section extends rearward of the rear of the contact holder. The ground bus includes ground rails connected to the ground contacts each having a front mating finger coupled to the forward portion of the corresponding ground contact and a rear mating finger coupled to the rearward portion of the corresponding ground contact.

### BACKGROUND OF THE INVENTION

The subject matter herein relates generally to electrical connector assemblies.

Some communication systems utilize communication connectors, such as electrical connector assemblies to interconnect various components of the system for data communication. Some known communication systems use pluggable modules, such as I/O modules or circuit cards, which are electrically connected to the electrical connector assemblies. The pluggable modules have module circuit cards having card edges that are mated with the electrical connector assemblies during the mating operation. Each electrical connector assembly typically has an upper row of contacts and a lower row of contacts for mating with the corresponding circuit board. There is a need for connectors and circuit boards of communication systems to have greater contact density and/or data throughput. Additionally, there is a trend to increase data rates. High speed data signals have shorter frequency wavelengths, leading to increased noise and reduction in signal integrity. Shielding of the electrical connectors improves signal integrity. However, addition of shielding increases the overall cost of the electrical connector.

A need remains for an improved electrical connector assembly for a communication system.

### BRIEF DESCRIPTION OF THE INVENTION

In one embodiment, a cable assembly is provided and includes cables each having at least one conductor and a cable shield providing shielding for the at least one conductor. The cable assembly includes a contact assembly coupled to the cables. The contact assembly includes a contact holder, contacts held by the contact holder, and a ground bus coupled to the contact holder. The contact holder includes a front and a rear. The contact holder includes an inner end and an outer end that extends between the front and the rear of the contact holder. The contact holder includes contact channels that extend between the front and the rear. The contacts are arranged in a row. The contacts include signal contacts and ground contacts arranged between corresponding signal contacts to provide shielding between the corresponding signal contacts. The ground contacts are electrically connected to the cable shields of the corresponding cables. Each contact includes a forward section, a rearward section, and an intermediate section between the forward section and the rearward section. The intermediate section received in the corresponding contact channel and passes through the contact holder. The forward section extends forward of the front of the contact holder. The rearward section extends rearward of the rear of the contact holder. The forward section includes a spring beam configured to be mated to a mating component. The rearward section includes a terminating end terminated to corresponding cable. The ground bus includes ground rails connected to the ground contacts. Each ground rail includes a front mating finger coupled to the forward portion of the corresponding ground contact. Each ground rail includes a rear mating finger, discrete from the front mating finger, coupled to the rearward portion of the corresponding ground contact.

In another embodiment, an electrical connector assembly is provided and includes a housing having a cavity. The housing has a slot at a housing front of the housing configured to receive a mating component. The electrical connector assembly includes a cable assembly received in the cavity. The cable assembly includes cables and a contact assembly coupled to the cables. The cables each have at least one conductor and a cable shield providing shielding for the at least one conductor. The contact assembly includes a contact holder, contacts held by the contact holder, and a ground bus coupled to the contact holder. The contact holder includes a front and a rear. The contact holder includes an inner end and an outer end that extends between the front and the rear of the contact holder. The contact holder includes contact channels that extend between the front and the rear. The contacts are arranged in a row. The contacts include signal contacts and ground contacts arranged between corresponding signal contacts to provide shielding between the corresponding signal contacts. The ground contacts are electrically connected to the cable shields of the corresponding cables. Each contact includes a forward section, a rearward section, and an intermediate section between the forward section and the rearward section. The intermediate section received in the corresponding contact channel and passes through the contact holder. The forward section extends forward of the front of the contact holder. The rearward section extends rearward of the rear of the contact holder. The forward section includes a spring beam configured to be mated to the mating component. The rearward section includes a terminating end terminated to corresponding cable. The ground bus includes ground rails connected to the ground contacts. Each ground rail includes a front mating finger coupled to the forward portion of the corresponding ground contact. Each ground rail includes a rear mating finger, discrete from the front mating finger, coupled to the rearward portion of the corresponding ground contact.

In a further embodiment, a receptacle connector assembly is provided and includes a receptacle cage having walls forming a cavity defining a module channel configured to receive a pluggable module. The receptacle connector assembly includes an electrical connector assembly received in the cavity to mate with the pluggable module. The electrical connector assembly includes a housing and a cable assembly received in the housing. The housing having a housing cavity and a slot at a housing front of the housing configured to receive module circuit board of the pluggable module. The cable assembly includes cables and a contact assembly coupled to the cables. The cables each have at least one conductor and a cable shield providing shielding for the at least one conductor. The contact assembly includes a contact holder, contacts held by the contact holder, and a ground bus coupled to the contact holder. The contact holder includes a front and a rear. The contact holder includes an inner end and an outer end extends between the front and the rear of the contact holder. The contact holder includes contact channels that extend between the front and the rear. The contacts arranged in a row. The contacts include signal contacts and ground contacts arranged between corresponding signal contacts to provide shielding between the corresponding signal contacts. The ground contacts electrically connected to the cable shields of the corresponding cables. Each contact includes a forward section, a rearward section, and an intermediate section between the forward section and the rearward section. The intermediate section received in the corresponding contact channel and passes through the contact holder. The forward section extends forward of the front of the contact holder. The rearward section extends rearward of the rear of the contact holder. The forward section includes a spring beam configured to be mated to the mating component. The rearward section includes a terminating end terminated to corresponding cable. The ground bus includes ground rails connected to the ground contacts. Each ground rail includes a front mating finger coupled to the forward portion of the corresponding ground contact. Each ground rail includes a rear mating finger, discrete from the front mating finger, coupled to the rearward portion of the corresponding ground contact.

### BRIEF DESCRIPTION OF THE DRAWINGS

FIG. 1 is a front perspective view of a communication system formed in accordance with an exemplary embodiment.

FIG. 2 is a rear perspective view of the mating component in accordance with an exemplary embodiment.

FIG. 3 is a front perspective view of the electrical connector assembly in accordance with an exemplary embodiment.

FIG. 4 is a front perspective view of a portion of the electrical connector assembly in accordance with an exemplary embodiment.

FIG. 5 is an exploded view of the cable assembly in accordance with an exemplary embodiment.

FIG. 6 is an assembled view of the cable assembly in accordance with an exemplary embodiment.

FIG. 7 is a front perspective view of the contact assembly in accordance with an exemplary embodiment.

FIG. 8 is a rear perspective view of the contact assembly in accordance with an exemplary embodiment.

FIG. 9 is a side view of the cable assembly in accordance with an exemplary embodiment.

FIG. 10 is a sectional view of a portion of the electrical connector assembly in accordance with an exemplary embodiment.

### DETAILED DESCRIPTION OF THE INVENTION

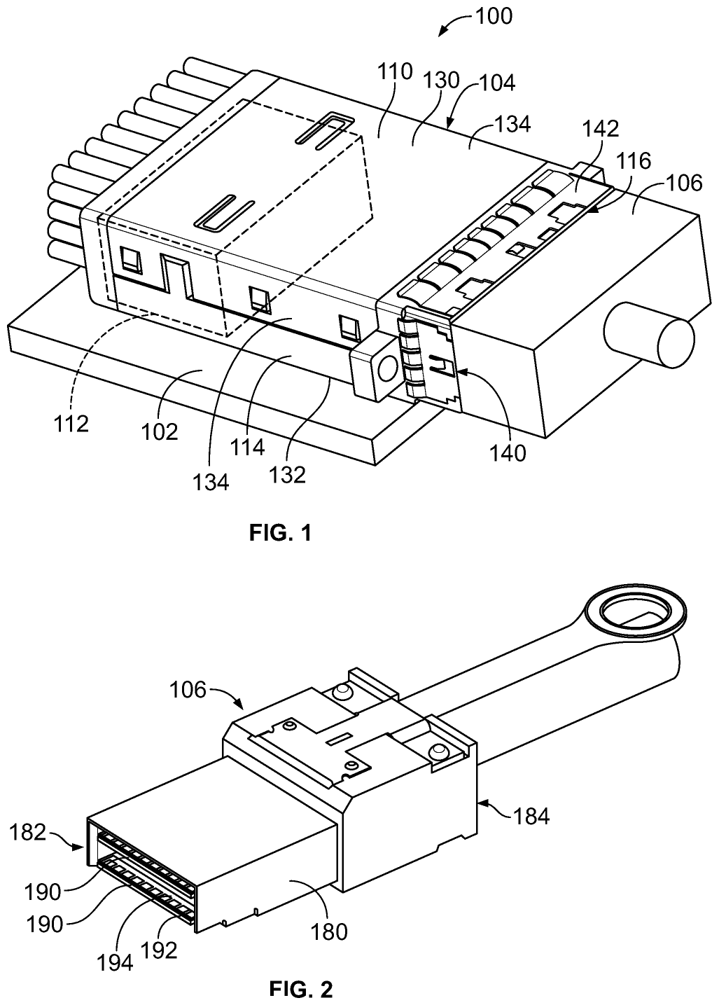

FIG. 1 is a front perspective view of a communication system 100 formed in accordance with an exemplary embodiment. The communication system 100 includes a device 102 and a receptacle connector assembly 104 mounted to the device 102. The device 102 may be a circuit board in various embodiments. The device 102 may be a housing, chassis, panel, or other type of device in other various embodiments, such as arranged at the front of the connector assembly. For example, the device 102 may be a vertical wall (not shown) such as a panel or chassis with an opening or cutout that receives a portion of the receptacle connector assembly 104. The receptacle connector assembly 104 may be coupled to the device 102 using mounting lugs or brackets. The device may be oriented horizontally, vertically, or at another orientation. A mating component is configured to be electrically connected to the receptacle connector assembly 104. The mating component may be a pluggable module 106, such as an I/O module or a transceiver module. The mating component may be electrically connected to the device 102. The mating component may be connected to other components within the communication system 100, such as an integrated circuit component, a chip, a microprocessor, a memory module, or another component of the communication system, through cable connectors. The other components may be mounted to the device 102, such as remote from the receptacle connector assembly 104.

In an exemplary embodiment, the receptacle connector assembly 104 includes a receptacle cage 110 and an electrical connector assembly 112 (shown in phantom) adjacent the receptacle cage 110. For example, in the illustrated embodiment, the electrical connector assembly 112 is received in the receptacle cage 110. In other various embodiments, the electrical connector assembly 112 may be located rearward of the receptacle cage 110. In various embodiments, the electrical connector assembly 112 is a card edge connector and may be referred to hereinafter as a card edge connector 112. The electrical connector assembly 112 may be electrically connected to the device 102. The electrical connector assembly 112 may be connected to other components by cables of a cable connector.

In various embodiments, the receptacle cage 110 is enclosed and provides electrical shielding for the electrical connector assembly 112. The pluggable module 106 is loaded into the receptacle cage 110 and is at least partially surrounded by the receptacle cage 110. The receptacle cage 110 includes a plurality of walls 114 that define one or more module channels 116 for receipt of corresponding pluggable module(s) 106. The walls 114 may be walls defined by solid sheets, perforated walls to allow airflow therethrough, walls with cutouts, such as for a heatsink or heat spreader to pass therethrough, or walls defined by rails or beams with relatively large openings, such as for airflow therethrough.

In the illustrated embodiment, the receptacle cage 110 is a single port cage having a single module channel 116. In alternative embodiments, the receptacle cage 110 constitutes a multi-port cage having multiple module channels 116. The module channels 116 may be arranged in a single row or may be stacked in multiple rows. In various embodiments, the receptacle cage 110 may include four module channels 116 arranged in a single row (for example, 1×4). However, the receptacle cage 110 may include multiple rows in alternative embodiments (for example, 2×2, 3×2, 4×2, 4×3, etc.). Any number of module channels 116 may be provided in various embodiments. Optionally, multiple electrical connector assemblies 112 may be arranged within the receptacle cage 110 for mating with the corresponding pluggable module 106.

In an exemplary embodiment, the walls 114 of the receptacle cage 110 include a top wall 130, a bottom wall 132, and side walls 134 extending between the top wall 130 and the bottom wall 132. The bottom wall 132 may rest on the device 102. In other various embodiments, the receptacle cage 110 may be provided without the bottom wall 132. Optionally, the module channel 116 may be open at the front and the rear. However, the walls 114 of the receptacle cage 110 may include a rear wall and/or a front wall.

The walls 114 define a cavity 140, which defines one or more of the module channels 116. For example, the cavity 140 may be defined by the top wall 130, the bottom wall 132, and the side walls 134. In an exemplary embodiment, other walls 114 may separate or divide the cavity 140 into the various module channels 116. For example, the walls 114 may include divider walls between the module channels 116.

In an exemplary embodiment, the receptacle cage 110 may include one or more gaskets 142 at the front and/or the rear for providing electrical shielding for the ports to the module channels 116. For example, the gaskets 142 may be configured to electrically connect with the pluggable module 106 and/or the opening in the device 102 where the receptacle cage 110 is mounted. The gaskets 142 may be configured to electrically connect to a panel or bezel.

In an exemplary embodiment, the receptacle connector assembly 104 may include one or more heat sinks (not shown) for dissipating heat from the pluggable module 106. For example, the heat sinks may be coupled to the top wall 130 for engaging the pluggable module 106 received in the module channels 116. The heat sinks may extend through openings in the top wall 130 to directly engage the pluggable module 106. Other types of heat sinks may be provided in alternative embodiments.

In an exemplary embodiment, each electrical connector assembly 112 is received in the cavity 140, such as at the rear. The electrical connector assembly 112 may be removable from the receptacle cage 110. In an exemplary embodiment, the pluggable module 106 are loaded through the front to mate with the electrical connector assembly 112. The shielding walls 114 of the receptacle cage 110 provide electrical shielding around the electrical connector assembly 112 and the pluggable module 106, such as around the mating interfaces between the electrical connector assembly 112 and the pluggable module 106.

FIG. 2 is a rear perspective view of the mating component in accordance with an exemplary embodiment. In the illustrated embodiment, the mating component is a pluggable module 106. The pluggable module 106 has a pluggable body 180, which may be defined by one or more shells. The pluggable body 180 may be thermally conductive and/or may be electrically conductive, such as to provide EMI shielding for the pluggable module 106. The pluggable body 180 includes a mating end 182 and an opposite front end 184. The mating end 182 is configured to be inserted into the corresponding module channel 116 (shown in FIG. 1). The front end 184 may be a cable end having a cable extending therefrom to another component within the system.

The pluggable module 106 includes one or more module circuit cards 190 that is/are configured to be communicatively coupled to the electrical connector assembly 112 (shown in FIG. 1). Each module circuit card 190 may be accessible at the mating end 182. The module circuit card 190 has a card edge 192 extending between a first or upper surface and a second or lower surface at a mating end of the module circuit card 190. The module circuit card 190 includes mating contacts 194, such as pads or circuits, at the card edge 192 configured to be mated with the electrical connector assembly 112. In an exemplary embodiment, the mating contacts 194 are provided on the upper surface and the lower surface. The module circuit card 190 may include components, circuits and the like used for operating and or using the pluggable module 106. For example, the module circuit card 190 may have conductors, traces, pads, electronics, sensors, controllers, switches, inputs, outputs, memory, and the like associated with the module circuit card 190, which may be mounted to the module circuit card 190, to form various circuits.

In other various embodiments, the mating component may be a circuit card rather than an I/O module. For example, the mating component may include the module circuit card(s) 190 without the pluggable body 180 surrounding the module circuit card 190. For example, the mating component may be a paddle card.

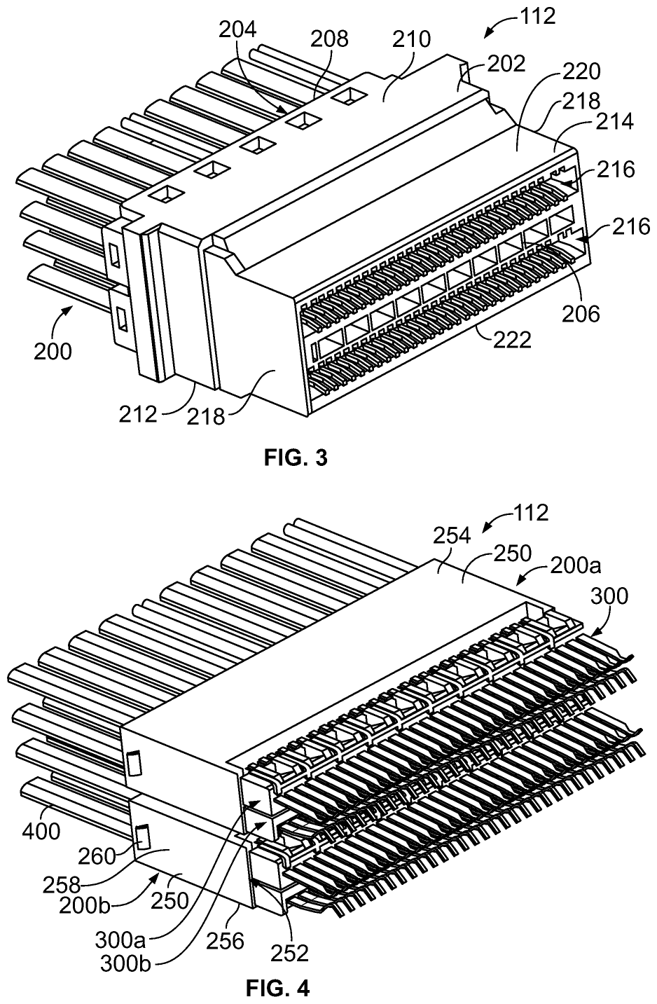

FIG. 3 is a front perspective view of the electrical connector assembly 112 in accordance with an exemplary embodiment. FIG. 4 is a front perspective view of a portion of the electrical connector assembly 112 in accordance with an exemplary embodiment. The electrical connector assembly 112 includes one or more cable assemblies 200 and a housing 202 holding the cable assemblies 200. FIG. 3 shows the electrical connector assembly 112 with the housing 202. FIG. 4 shows the electrical connector assembly 112 without the housing 202 to illustrate the cable assemblies 200. Each cable assembly 200 includes one or more contact assemblies 300 and cables 400 terminated to the corresponding contact assembly 300.

The housing 202 includes a cavity 204 that receives the cable assemblies 200. The housing 202 extends between a front 206 and a rear 208. The cavity 204 is open at the rear 208 to receive the cable assemblies 200. The housing 202 extends between a top 210 and a bottom 212. The housing 202 extends between opposite sides 218. The housing 202 may be generally box shaped in various embodiments. In the illustrated embodiment, the bottom 212 may define a mounting end configured to be mounted to the device 102 (shown in FIG. 1) and/or the receptacle cage 110. The sides 218 may define mounting ends configured to be mounted to the receptacle cage 110 and/or the device 102. The front 206 defines a mating end configured to be mated with the pluggable module 106 (shown in FIG. 1). Other orientations are possible in alternative embodiments.

The housing 202 includes a top wall 220 at the top 210 and a bottom wall 222 at the bottom 212. In the illustrated embodiment, the housing 202 includes a shroud 214 at the front 206 configured to be mated with the pluggable module 106. The shroud 214 is a nose cone configured to be plugged into the mating ends of the pluggable module 106. The shroud 214 includes one or more housing card slots 216 open at the front. In the illustrated embodiment, the shroud 214 includes a pair of the card slots 216. However, in alternative embodiments, the shroud 214 may include greater or fewer card slots 216, such as a single card slot 216. In other various embodiments, the housing 202 may include multiple shrouds 214, which may be plugged into different pluggable modules (for example, an upper module and a lower module). The housing card slot(s) 216 receives the card edge 192 (shown in FIG. 2) of the corresponding module circuit card 190 (shown in FIG. 2). In an exemplary embodiment, the contact assembly 300 is loaded in the cavity 204 and received in the shroud 214 for mating with the pluggable module 106.

In an exemplary embodiment, each cable assembly 200 includes a pair of the contact assemblies 300, such as an upper contact assembly 300a and a lower contact assembly 300b. The upper contact assembly 300a includes upper contacts and the lower contact assembly 300b includes lower contacts facing each other across a gap configured to receive the mating component (for example, the module circuit card 190). The upper and lower contact assemblies 300a, 300b may be similar or identical contact assemblies (for example, similarly or identically manufactured and/or assembled). The upper and lower contact assemblies 300a, 300b may be inverted relative to each other to form an upper mating interface for mating to the upper surface of the module circuit card 190 and a lower mating interface for mating to the lower surface of the module circuit card 190. The cables 400 are terminated to the corresponding contacts of the contact assemblies 300. In an exemplary embodiment, each cable assembly 200 includes a carrier 250 holding the contact assemblies 300 and/or the cables 400. The carrier 250 may hold the contact assemblies 300 in a stack. In the illustrated embodiment, multiple carriers 250 are provided corresponding to an upper cable assembly 200a and a lower cable assembly 200b. However, in other embodiments, a single carrier 250 may be used to hold both upper and lower cable assemblies 200a, 200b or a single carrier 250 and single cable assembly 200 may be used in alternative embodiments.

In an exemplary embodiment, the carrier 250 includes walls forming a cavity 252. The walls include a top wall 254, a bottom wall 256, and side walls 258 between the top and bottom walls 254, 256. The cavity 252 may be open at the front and/or at the rear. The contact assemblies 300 may extend from the front and/or the rear. The cables 400 may extend from the carrier 250, such as from the rear. The carrier 250 may be generally box-shaped. However, the carrier 250 may have other shapes in alternative embodiments. The carrier 250 includes securing features 260 for securing the carrier 250 in the housing 202. The securing features 260 may be latches, clips, or other types of securing features. The carrier 250 may include securing features (not shown) for securing the contact assemblies 300 in the carrier 250.

The cable assembly 200 includes a plurality of the cables 400 configured to be terminated to the contact assembly 300. The cables 400 may be arranged in multiple rows. In an exemplary embodiment, the cables 400 are twin-axial cables each having a pair of signal conductors arranged in the core of the cable 400. The cables 400 may be shielded cables having cable shields surrounding the pairs of signal conductors. The cables 400 may include drain wires. Other types of cables may be used in alternative embodiments, such as coaxial cables, flat flexible cables, flexible circuits, twisted pair cables, and the like. In an exemplary embodiment, the cables 400 define high speed signal cables configured to transmit high speed data signals, such as 10 Gbps, 25 Gbps, 40 Gbps, 64 Gbps, 100 Gbps, or higher.

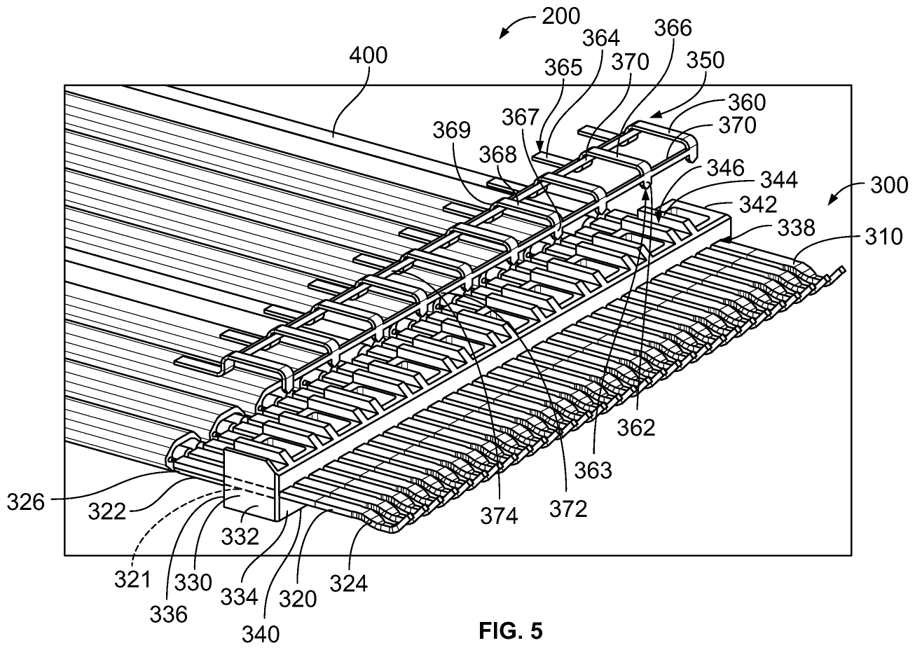

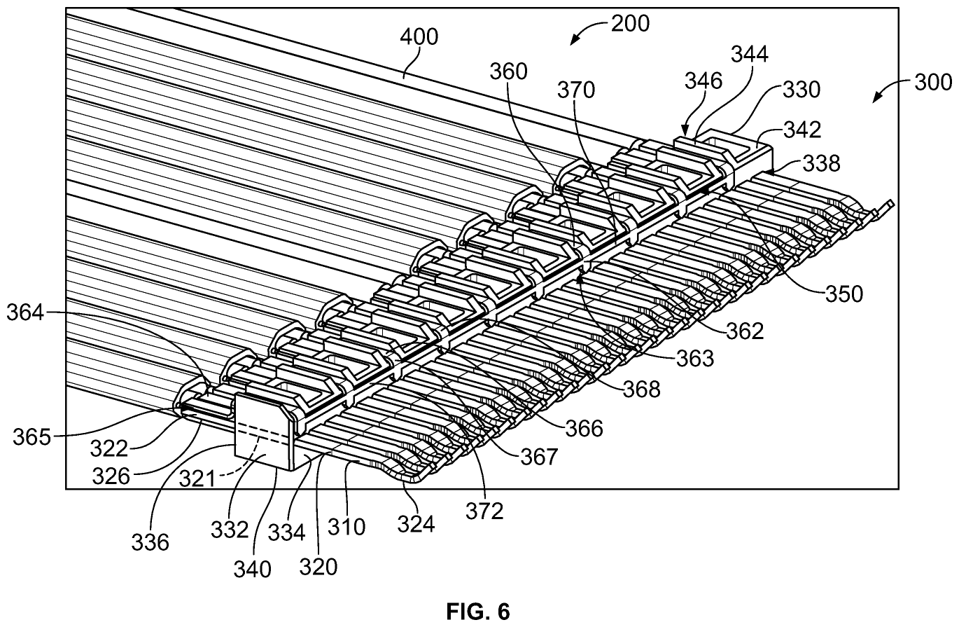

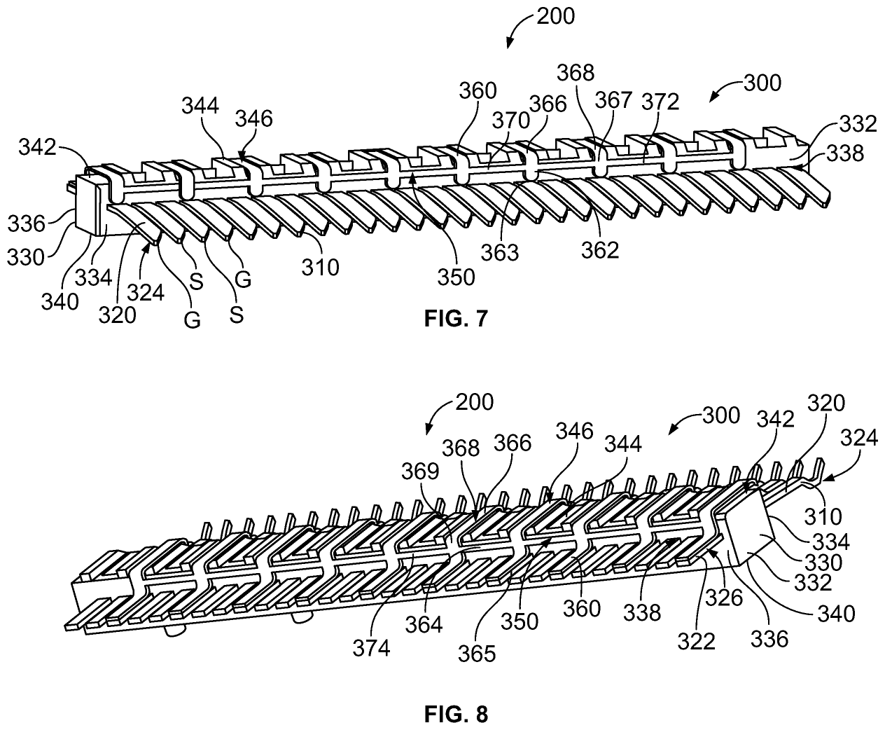

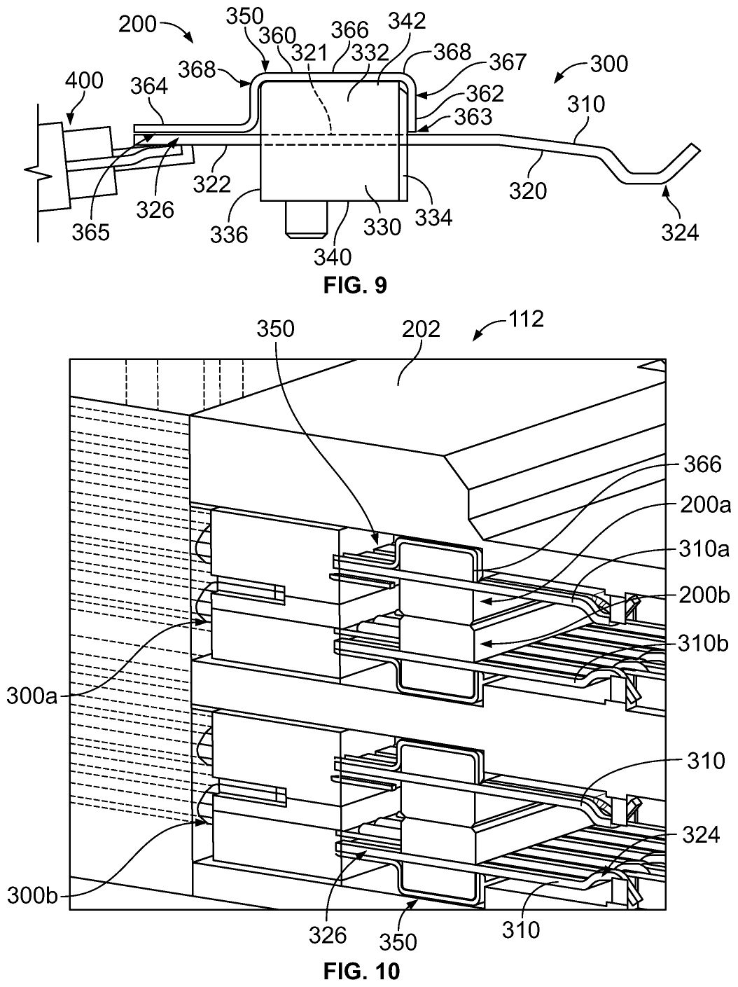

FIG. 5 is an exploded view of the cable assembly 200 in accordance with an exemplary embodiment. FIG. 6 is an assembled view of the cable assembly 200 in accordance with an exemplary embodiment. FIG. 7 is a front perspective view of the contact assembly 300 in accordance with an exemplary embodiment. FIG. 8 is a rear perspective view of the contact assembly 300 in accordance with an exemplary embodiment. FIG. 9 is a side view of the cable assembly 200 in accordance with an exemplary embodiment.

In an exemplary embodiment, the cable assembly 200 includes the contact assembly 300 and the cables 400 terminated to the contact assembly 300. The contact assembly 300 includes an array of contacts 310, a contact holder 330 holding the contacts 310, and a ground bus 350 coupled to the contact holder 330 and the corresponding contacts 310. The ground bus 350 is configured to be electrically coupled to the cable shield and/or the drain wires of the cables 400. In an exemplary embodiment, the contacts 310 include signal contacts and ground contacts. The ground contacts are interspersed with the signal contacts, such as to provide shielding between the signal contacts. In an exemplary embodiment, the signal contacts are arranged in pairs, such as to convey differential signals. The contacts 310 may be arranged in a ground-signal-signal-ground (G-S-S-G) arrangement. Other arrangements are possible in alternative embodiments. In an exemplary embodiment, the ground bus 350 is electrically connected to each of the ground contacts, such as to common the ground contacts.

The contact holder 330 supports the array of contacts 310, such as in a row. The contact holder 330 is used to position the contacts 310 relative to each other. The contact holder 330 includes a main body 332 extending between a front 334 and a rear 336 of the contact holder 330. The front 334 may be planar. The rear 336 may be planar. The front 334 may be parallel to the rear 336. The contact holder 330 includes contact channels 338 that receive corresponding contacts 310. The contact channels 338 extend between the front 334 and the rear 336. The main body 332 extends between opposite sides of the contact holder 330. The main body 332 is manufactured from a dielectric material, such as a plastic material. In various embodiments, the main body 332 may be an overmold body overmolded over the contacts 310 to hold the contacts 310 relative to each other. The contacts 310 may extend forward from the front 334, such as for mating with the module circuit card 190. The contacts 310 may extend rearward from the rear 336, such as for termination to the cables 400.

In an exemplary embodiment, the contact holder 330 includes an inner end 340 and an outer end 342. The main body 332 surrounds the contact channels 338, such as being positioned between the contact channels 338 and the ends 340, 342. The inner end 340 may face the inner end of another contact holder of another contact assembly to form the cable assembly. For example, the inner ends 340 of the contact holders 330 of upper and lower contact assemblies may abut against each other in a stacked arrangement to form the cable assembly 200. The outer end 342 includes separating walls 344 forming grooves 346. The grooves 346 receive the ground bus 350. The grooves 346 may be open at the outer end, such as the top of the contact holder 330.

In an exemplary embodiment, the contacts 310 are stamped and formed contacts. The contacts 310 may be formed from a leadframe. For example, the leadframe is stamped from a metal plate to define the contacts 310. Each contact 310 includes a forward section 320, a rearward portion 322, and an intermediate section 321 between the forward and rearward sections 320, 322. The intermediate section 321 is held by the contact holder 330. For example, the intermediate section 321 is received in the corresponding contact channel 338 and passes through the contact holder 330. The forward section 320 extends forward from the contact holder 330 to mate with the module circuit card 190. The forward section 320 is forward of the front 334 of the contact holder 330. In an exemplary embodiment, the forward section 320 includes a spring beam 324 having a mating interface configured to be mated with the module circuit card 190. The spring beam 324 is cantilevered from the contact holder 330. The spring beam 324 is deflectable, such as being deflected outward when mated to the module circuit card 190. In an exemplary embodiment, the rearward portion 322 includes a terminating end 326. The terminating end 326 is configured to be terminated to the corresponding cable 400. For example, the terminating end 326 includes a solder pad configured to be soldered to the cable 400 such as to the conductor. The rearward portion 322 extends rearward from the contact holder 330, such as for termination to the cable 400. The rearward portion 322 is rearward of the rear 336 of the contact holder 330. The rearward portion 322 is cantilevered from the contact holder 330.

The ground bus 350 is configured to be coupled to the contact holder 330. The ground bus 350 is configured to be electrically connected to the corresponding contacts 310, such as the ground contacts. The ground bus 350 includes ground rails 360 connected to the corresponding ground contacts 310. In an exemplary embodiment, the ground bus 350 includes connecting rails 370 between the ground rails 360. In an exemplary embodiment, the ground bus 350 is a stamped and formed part. For example, the ground bus 350 may be stamped from a metal plate and formed into a predetermined shape. The ground rails 360 are connected to each other by the connecting rails 370 as a single unitary structure.

In an exemplary embodiment, each ground rail 360 includes a front mating finger 362 and a rear mating finger 364 discrete from the front mating finger 362. Each ground rail 360 includes an intermediate portion 366 between the front mating finger 362 and the rear mating finger 364. The intermediate portion 366 is configured to be coupled to the contact holder 330. For example, the intermediate portion 366 is coupled to the outer end 342 of the contact holder 330. In an exemplary embodiment, the intermediate portion 366 is received in the corresponding groove 346 between the separating walls 344. The separating walls 344 locate the intermediate portion 366. In alternative embodiments, the intermediate portion 366 may be overmolded by the contact holder 330.

In an exemplary embodiment, the intermediate portion 366 includes a cap 368 coupled to the outer end 342. In an exemplary embodiment, the ground rail 360 includes a front bumper 367 extending along the front 334 of the contact holder 330 and a rear bumper 369 extending along the rear 336 of the contact holder 330. The ground rail 360 is positioned relative to the contact holder 330 by the front and rear bumpers 367, 369. For example, the contact holder 330 is captured between the front and rear bumpers 367, 369. The ground rail 360 is blocked from rearward movement by interference between the front bumper 367 and the front 334 of the contact holder 330. The ground rail 360 is blocked from forward movement by interference between the rear bumper 369 and the rear 336 of the contact holder 330. The cap 368 extends along the outer end 342 of the contact holder 330 between the front bumper 367 and the rear bumper 369. The cap 368 of the intermediate portion 366 may be connected to the front bumper 367 and/or the front mating finger 362 at a bend or corner. The cap 368 of the intermediate portion 366 may be connected to the rear bumper 369 and/or the rear mating finger 364 at a bend or corner. In an exemplary embodiment, the connecting rails 370 may connect the intermediate portions 366.

The front mating finger 362 extends from the intermediate portion 366. The front mating finger 362 is configured to be coupled to the forward section 320 of the corresponding ground contact 310. The front mating finger 362 may be oriented perpendicular to the intermediate portion 366. For example, the front mating finger 362 may be oriented vertically. The front mating finger 362 extends along the front 334. The front mating finger 362 is forward of the front 334. In an exemplary embodiment, the front mating finger 362 includes a tip 363 configured to engage the forward section 320 of the corresponding ground contact 310. The tip 363 has a mating interface engaging the forward section 320. The tip 363 may directly engage the forward section 320. The tip 363 may be soldered to the ground contact 310. In other embodiments, the tip 363 may engage the ground contact 310 by an interference or simple mechanical connection (for example, touching). The tip 363 may be preloaded to maintain connection with the ground contact 310. In an exemplary embodiment, the front mating finger 362 is movable with the spring beam 324. For example, the front mating finger 362 may be deflected outward with the spring beam 324 when the spring beam 324 is mated with the module circuit card 190. In an exemplary embodiment, the front mating finger 362 engages the ground contact 310 immediately forward of the contact holder 330, such as at the front 334. The front mating finger 362 engages the ground contact 310 remote from the rearward portion 322. For example, the front mating finger 362 is separated from the rear mating finger 364 by a distance. In an exemplary embodiment, the connecting rails 370 may connect the front mating fingers 362.

The rear mating finger 364 extends from the intermediate portion 366. The rear mating finger 364 is configured to be coupled to the rearward portion 322 of the corresponding ground contact 310. The rear mating finger 364 may be oriented perpendicular to the intermediate portion 366. The rear mating finger 364 may be L-shaped including a vertical portion extending from the intermediate portion 366 and a horizontal portion extending rearward from the vertical portion. The rear mating finger 364 extends along the rear 336. The rear mating finger 364 is rearward of the rear 336. In an exemplary embodiment, the rear mating finger 364 includes a tail 365 configured to engage the rearward portion 322 of the corresponding ground contact 310. The tail 365 has a mating interface engaging the rearward portion 322. The tail 365 may directly engage the rearward portion 322, such as extending along and parallel to the terminating end 326. The tail 365 may be soldered to the ground contact 310, such as to the outer surface of the terminating end 326. In other embodiments, the tail 365 may engage the ground contact 310 by an interference or simple mechanical connection (for example, touching). In an exemplary embodiment, the rear mating finger 364 engages the ground contact 310 immediately rearward of the contact holder 330, such as at the rear 336. The rear mating finger 364 may extend along the terminating end 326 rearward of the contact holder 330, such as extending to the distal end of the terminating end 326. The rear mating finger 364 engages the ground contact 310 remote from the forward section 320. For example, the rear mating finger 364 is separated from the front mating finger 362 by a distance. In an exemplary embodiment, the connecting rails 370 may connect the front mating fingers 362.

The ground bus 350 includes the connecting rails 370 extending between and electrically connecting the ground rails 360. In an exemplary embodiment, the connecting rails 370 include front connecting rails 372 connecting the front mating fingers 362 and rear connecting rails 374 connecting the rear mating fingers 364. The front connecting rails 372 extend along the front 334 of the contact holder 330. The rear connecting rails 374 extend along the rear 336 of the contact holder 330.

FIG. 10 is a sectional view of a portion of the electrical connector assembly 112 in accordance with an exemplary embodiment. FIG. 10 shows the upper and lower cable assemblies 200a, 200b received in the housing 202. Each of the cable assemblies 200a, 200b include a pair of the contact assemblies 300. The pair of contact assemblies 300 form upper contacts 310a and lower contacts 310b arranged on opposite sides of the card slot to mate with opposite sides of the module circuit card 190. The ground bus 350 of each contact assembly 300 is electrically commoned to each ground contact 310 at multiple points of contact. In an exemplary embodiment, the front mating fingers 366 are connected to the ground contacts 310 at a location between the terminating ends 326 and the mating interfaces at the distal ends of the spring beams 324. For example, the points of contact of the front mating fingers 366 may be approximately centered between the terminating ends 326 and the mating interfaces at the distal ends of the spring beams 324 to reduce the effective lengths of the ground paths, such as to improve signal integrity.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A cable assembly comprising:
cables each having at least one conductor and a cable shield providing shielding for the at least one conductor; and
a contact assembly coupled to the cables, the contact assembly including a contact holder, contacts held by the contact holder, and a ground bus coupled to the contact holder;
the contact holder including a front and a rear, the contact holder including an inner end and an outer end extending between the front and the rear of the contact holder, the contact holder including contact channels extending between the front and the rear;
the contacts arranged in a row, the contacts including signal contacts and ground contacts arranged between corresponding signal contacts to provide shielding between the corresponding signal contacts, the ground contacts electrically connected to the cable shields of the corresponding cables, each contact including a forward section, a rearward section, and an intermediate section between the forward section and the rearward section, the intermediate section received in the corresponding contact channel and passing through the contact holder, the forward section extending forward of the front of the contact holder, the rearward section extending rearward of the rear of the contact holder, the forward section including a spring beam configured to be mated to a mating component, the rearward section including a terminating end terminated to corresponding cable; and
the ground bus including ground rails connected to the ground contacts, each ground rail including a front mating finger coupled to the forward portion of the corresponding ground contact, each ground rail including a rear mating finger, discrete from the front mating finger, coupled to the rearward portion of the corresponding ground contact.

2. The cable assembly of claim 1, wherein the front mating finger is directly connected to the forward section of the corresponding ground contact.

3. The cable assembly of claim 1, wherein the rear mating finger is soldered to the rearward section of the corresponding ground contact.

4. The cable assembly of claim 1, wherein the front mating finger includes a tip facing and engaging the spring beam of the corresponding ground contact.

5. The cable assembly of claim 1, wherein the rear mating finger includes a tail extending along and parallel to the rearward section of the corresponding ground contact.

6. The cable assembly of claim 1, wherein the ground bus includes connecting rails extending between and electrically connecting the ground rails.

7. The cable assembly of claim 6, wherein the connecting rails include front connecting rails connecting the front mating fingers and rear connecting rails connecting the rear mating fingers.

8. The cable assembly of claim 1, wherein the front mating finger extends along the front of the contact holder and the rear mating finger extends along the rear of the contact holder.

9. The cable assembly of claim 1, wherein the ground rail includes a front bumper extending along the front of the contact holder, a rear bumper extending along the rear of the contact holder, and a cap extending along the outer end of the contact holder between the front bumper and the rear bumper.

10. The cable assembly of claim 1, wherein the contact holder includes slots receiving the corresponding ground rails, the ground rails being movable in the slots.

11. The cable assembly of claim 1, wherein the spring beams are deflectable when mating with the mating component, the front mating fingers being deflectable with the corresponding spring beams.

12. The cable assembly of claim 1, wherein the contacts are arranged in a ground-signal-signal-ground arrangement.

13. An electrical connector assembly comprising:
a housing having a cavity, the housing having a slot at a housing front of the housing configured to receive a mating component;
a cable assembly received in the cavity, the cable assembly including cables and a contact assembly coupled to the cables, the cables each having at least one conductor and a cable shield providing shielding for the at least one conductor, the contact assembly including a contact holder, contacts held by the contact holder, and a ground bus coupled to the contact holder;
the contact holder including a front and a rear, the contact holder including an inner end and an outer end extending between the front and the rear of the contact holder, the contact holder including contact channels extending between the front and the rear;
the contacts arranged in a row, the contacts including signal contacts and ground contacts arranged between corresponding signal contacts to provide shielding between the corresponding signal contacts, the ground contacts electrically connected to the cable shields of the corresponding cables, each contact including a forward section, a rearward section, and an intermediate section between the forward section and the rearward section, the intermediate section received in the corresponding contact channel and passing through the contact holder, the forward section extending forward of the front of the contact holder, the rearward section extending rearward of the rear of the contact holder, the forward section including a spring beam configured to be mated to the mating component, the rearward section including a terminating end terminated to corresponding cable; and
the ground bus including ground rails connected to the ground contacts, each ground rail including a front mating finger coupled to the forward portion of the corresponding ground contact, each ground rail including a rear mating finger, discrete from the front mating finger, coupled to the rearward portion of the corresponding ground contact.

14. The electrical connector assembly of claim 13, wherein the contact assembly is an upper contact assembly configured to interface with an upper portion of the mating component, the cable assembly further comprising a lower contact assembly configured to interface with a lower portion of the mating component.

15. The electrical connector assembly of claim 13, wherein the front mating finger is directly connected to the forward section of the corresponding ground contact and the rear mating finger is soldered to the rearward section of the corresponding ground contact.

16. The electrical connector assembly of claim 13, wherein the front mating finger includes a tip facing and engaging the spring beam of the corresponding ground contact and the rear mating finger includes a tail extending along and parallel to the rearward section of the corresponding ground contact.

17. The electrical connector assembly of claim 13, wherein the ground bus includes connecting rails extending between and electrically connecting the ground rails.

18. The electrical connector assembly of claim 13, wherein the front mating finger extends along the front of the contact holder and the rear mating finger extends along the rear of the contact holder, the ground rail including a cap extending along the outer end of the contact holder between the front mating finger and the rear mating finger.

19. The electrical connector assembly of claim 13, wherein the contact holder includes slots receiving the corresponding ground rails, the ground rails being movable in the slots.

20. A receptacle connector assembly comprising:
a receptacle cage having walls forming a cavity defining a module channel configured to receive a pluggable module; and
an electrical connector assembly received in the cavity to mate with the pluggable module, the electrical connector assembly including a housing and a cable assembly received in the housing, the housing having a housing cavity and a slot at a housing front of the housing configured to receive module circuit board of the pluggable module, the cable assembly including cables and a contact assembly coupled to the cables, the cables each having at least one conductor and a cable shield providing shielding for the at least one conductor, the contact assembly including a contact holder, contacts held by the contact holder, and a ground bus coupled to the contact holder;
the contact holder including a front and a rear, the contact holder including an inner end and an outer end extending between the front and the rear of the contact holder, the contact holder including contact channels extending between the front and the rear;
the contacts arranged in a row, the contacts including signal contacts and ground contacts arranged between corresponding signal contacts to provide shielding between the corresponding signal contacts, the ground contacts electrically connected to the cable shields of the corresponding cables, each contact including a forward section, a rearward section, and an intermediate section between the forward section and the rearward section, the intermediate section received in the corresponding contact channel and passing through the contact holder, the forward section extending forward of the front of the contact holder, the rearward section extending rearward of the rear of the contact holder, the forward section including a spring beam configured to be mated to the mating component, the rearward section including a terminating end terminated to corresponding cable; and
the ground bus including ground rails connected to the ground contacts, each ground rail including a front mating finger coupled to the forward portion of the corresponding ground contact, each ground rail including a rear mating finger, discrete from the front mating finger, coupled to the rearward portion of the corresponding ground contact.
